(19) United States
(12) Patent Application Publication
(10) Pub. No.: US 2018/0292296 A1
(43) Pub. Date: Oct. 11, 2018

(54) METHOD FOR DETERMINING THE MODAL PARAMETERS OF ROAD OR RAIL VEHICLES AND FOR THE IN-DIRECT CHARACTERIZATION OF ROAD OR RAIL PROFILES

(71) Applicant: POLITECNICO DI BARI, BARI (IT)

(72) Inventors: Giovanni DE FILIPPIS, Leporano (TA) (IT); Luigi MANGIALARDI, Bari (BA) (IT); Davide PALMIERI, San Giorgio Ionico (TA) (IT); Leonardo SORIA, Bari (BA) (IT)

(21) Appl. No.: 15/766,475

(22) PCT Filed: Oct. 16, 2015
(86) PCT No.: PCT/IT2015/000255

§ 371 Date: Apr. 6, 2018

(51) Int. Cl. G01M 17/08; G01M 17/007; G01B 21/30

(52) U.S. Cl. CPC G01M 17/08; G01B 21/30; G01M 17/007

(57) ABSTRACT

Method for the identification of poles (λₙ) and modal vectors (ψₙ) of a road or rail vehicle provided with at least two wheels and in working condition, by means of the analysis of the movements or speeds or accelerations (output of the system) acquired in assigned measuring points of said vehicle, wherein said poles and modal vectors are determined by means of the fitting of the data relating to said outputs of the system on the basis of a mathematical model which describes the interaction between road or railway and said vehicle, characterized by hypothesizing that said vehicle moves at constant speed on a rectilinear trajectory or bend with constant radius, hypothesizing that said vehicle moves on a homogeneous and ergodic surface, whose roughness has a Gaussian distribution and that said at least two wheels move on a profile or on a plurality of profiles parallel with respect to each other, hypo -thesizing that the inlets induced by the road or rail surface on said vehicle cannot be traced back to a sequence of white noises and are correlated with respect to each other in time and/or space.

The present invention relates to a method for the estimation of modal parameters of road/rail vehicle systems in working conditions and for the indirect characterization of statistic properties of roughness of rolling profiles on road/rail surfaces.

It is to be précised preliminarily that the method described in the following can be applied either to road or rail vehicle systems and that, therefore, the terms road surface and rail surface, road profile and rail profile, road and rail or railway are to be intended interchangeable throughout the text.

For an explanation of all the acronyms used, see the list at the end of the description.

### TECHNICAL FIELD

The application fields of the present invention are the Operational Modal Analysis, OMA, applied in case of road/rail vehicle systems and the characterization of roughness profiles of road/rail surfaces.

OMA is a technique commonly used to carry out the experimental identification of structures in working conditions and is based on the analysis of the sole output signals, generally acquired by using accelerometers. The experimental identification of a linear system with N degrees of freedom, subjected to working loads, aims at the estimation of so-called operational modal parameters, i.e.:
systems poles λₙ;
modal vectors ψₙ∈ [symbol] ^{N×1};
operational reference vectors ϕₙ∈ [symbol] ^{N×1}.

In particular, the determination of the system poles λₙ is crucial since they contain information about natural frequencies ωₙ and damping ratios ζₙ of the system examined

λₙ=(−ζₙ+i\sqrt{1−ζₙ²})ωₙ with n=1, . . . , N (1)

For characterization of the road/rail surface profiles it is intended the determination of the statistic properties associated to their roughness. Such characterization is generally carried out starting from direct measurements, carried out by means of suitable profilometers, and is aimed at a classification of the profiles belonging to various road surfaces or various rail elements.

### STATE OF THE ART

### Operational Modal Analysis

At the state of the art there are known various methods which allow to obtain the estimation of the modal parameters of structural systems starting from the analysis of the sole output signals, in case the hypotheses of natural excitation technique, NExT, are satisfied. In the separation domain (time-lag) ( [symbol] ) the output auto- and cross-correlation functions R_{q}_{ᵢ}_{q}_{ⱼ}(τ) (Eq. (3)) are commonly used. In the frequency domain (ω) instead, the modal parameters can be estimated directly from the auto- and cross-power spectral density, PSD, of the outputs S_{q}_{ᵢ}_{q}_{ⱼ}(ω), (Eq. (4)). In case in which Nᵢ external loads satisfy the NExT hypotheses, the input PSD matrix S_{f} can be written as a diagonal matrix with constant elements (eq. (2)).

$${S}_{f} = [ \begin{matrix}{S}_{1} & & 0 \\ & ⋱ & \\ 0 & & {S}_{{N}_{i}}\end{matrix} ] ∈ {ℂ}^{{N}_{i} \times {N}_{i}} \qquad ( 2 )$$

The above cited NExT hypotheses are in fact:

hypothesis 1: the loads acting on the system have to have a pattern which can be traced back to a sequence of white noises (amplitude independent of the frequency in eq. (2));

hypothesis 2: in case in which the excitation acts on many points, the inlets have to be strictly uncorrelated (absence of extra-diagonal elements in eq. (2)).

Referring to a generic system with N degrees of freedom, subjected to external loads which satisfy the NExT hypotheses, and considering the outputs qᵢ and qⱼ, we can write the expression of the cross-correlation as [Shen, DOI:10.1006/jsvi.2002.5203]

$${R}_{{q}_{i} {q}_{j}} ( τ ) = {\sum }_{n = 1}^{2 N} {φ}_{i n} {ψ}_{jn} {e}^{{λ}_{n} τ} h ( τ ) + {ψ}_{i n} {φ}_{jn} {e}^{- {λ}_{n} τ} h ( - τ ) \qquad ( 3 )$$

wherein:
ψᵢₙ and ψⱼₙ are two generic components of the modal vector ψₙ;
ϕᵢₙ and ϕⱼₙ are two generic components of the operational vector ϕₙ;
h(.) indicates the Heaviside function.

As a consequence, the cross-PSD expression can be obtained from eq. (3) by applying the Fourier transform

$${S}_{{q}_{i} {q}_{j}} ( ω ) = {\sum }_{n = 1}^{2 N} \frac{{φ}_{i n} {ψ}_{jn}}{i ω - {λ}_{n}} + \frac{{ψ}_{i n} {φ}_{jn}}{- i ω - {λ}_{n}} \qquad ( 4 )$$

Finally, re-writing eqs. (3) and (4) in compact matrix form, it is obtained:

$$\begin{matrix}{R}_{q} ( τ ) = {\sum }_{n = 1}^{2 N} {φ}_{n} {ψ}_{n}^{T} {e}^{{λ}_{n} τ} h ( τ ) + {ψ}_{n} {φ}_{n}^{T} {e}^{- {λ}_{n} τ} h ( - τ ) & ( 5 ) \\ {S}_{q} ( ω ) = {\sum }_{n = 1}^{2 N} \frac{{φ}_{n} {ψ}_{n}^{T}}{i ω - {λ}_{n}} + \frac{{ψ}_{n} {φ}_{n}^{T}}{- i ω - {λ}_{n}} & ( 6 )\end{matrix}$$

wherein:
R_{q}(τ)∈ [symbol] ^{N×N} is the output correlation matrix;
S_{q}(ω)∈ [symbol] ^{N×N} is the output PSD matrix;
the symbol (.)^{T} indicates the transpose operator matrix.

In particular, by grouping the various terms, eq. (6) can be re-written in more generic form as ratio between polynomial functions [Reynders, DOI: 10.1007/s11831-012-9069-x]

$${S}_{q} ( ω ) = \frac{B ( ω )}{A ( ω )} \qquad ( 7 )$$

where:
B(ω)∈ [symbol] ^{N×N} represents a matrix, whose generic element

$${B}_{ij} ( ω ) = {\sum }_{r = 0}^{{n}_{b}} {( i ω )}^{r} {b}_{ijr}$$

is the numerator polynomial of the corresponding PSD having coefficients bᵢⱼᵣ; the polynomials Bᵢⱼ(ω) are here defined as fitting polynomials and result associated to the inputs;

$$A ( ω ) = {\sum }_{r = 0}^{{n}_{a}} {( i ω )}^{r} {a}_{r}$$

is the denominator polynomial common to all the PSDs, having coefficients aᵣ; it represents the characteristic polynomial, whose roots are the system poles;
n_{b} and nₐ indicate the number of coefficients of the numerator and denominator polynomials, respectively.

The NExT hypotheses, for which eqs. (5), (6) and (7) are valid, are generally satisfied in civil engineering applications (buildings, bridges, civil structures in general), since in most cases the great constructions are exposed to stochastic loads (traffic and wind), which easily satisfy such hypotheses.

In the following, the main contributions available in Patent literature are described.

The application WO 01/33182 A1 describes the just introduced method for operational modal identification based on NExT hypotheses.

The application WO 2008/002310 A1 refers to a method for the extraction of modal parameters starting from FRFs. In order to obtain such functions it is needed to excite the structure with known signals. On the contrary, the OMA techniques do not require the inputs to be measured.

The application WO 2014/006176 A1 introduces a method for the estimation of the modal parameters of a structure, based on the use of transmissibilities. Such functions are obtained as ratio between two outputs of the system in a determined working condition. To eliminate the input influence is also needed to consider at least two different working conditions.

### Characterization of Roughness Profiles of Road/Rail Surfaces

In the last decades, the properties of random processes (random fields) have been widely studied and as a consequence the use of various approaches in modelling the road/rail roughness have emerged [Dodds&Robson, DOI:10.1016/80022-460X(73)80373-6]. In particular, underlying such models are three fundamental hypotheses.

Hypothesis 3: the surface is homogeneous, i.e. the statistic properties of roughness are independent of the spatial observation considered while referring to more parallel profiles;

hypothesis 4: the heights of roughness have a Gaussian distribution with null average, hence the statistic properties can be completely described by means of the correlation functions or by means of PSDs;

hypothesis 5: the surface is an ergodic process, i.e. the simple average, computed along the single realization, coincides with the ensemble average, computed along all the realizations.

In this contest, the technical literature suggests various approximations, the most part of which is based on the use of parametric models of measured PSDs. The parameters concerning such approximations are computed, starting from the acquired data, by using suitable fitting techniques. For example, the norm ISO 8608-1995 proposes the following auto-PSD model, defined in the domain of spatial frequency v

$${S}_{d ( ISO )} ( v ) = {{S}_{0} ( \frac{v}{{v}_{0}} )}^{- e} \qquad ( 8 )$$

where:
v₀ indicates the spatial frequency of reference (v₀=1 rad/m)
S₀(m³) is the amplitude of PSD for v=v₀.

The norm suggests to have the exponent e equal to 2 in case the data are acquired at constant speed. Therefore, if it is considered a profilometer which advances at a given speed v, the expression of eq. (8) can be converted in the time frequency domain ω and be re-written as

$${S}_{d ( ISO )} ( ω ) = {S}_{d ( ISO )} ( v = ω / v ) / v = \frac{{S}_{0}}{v} {( \frac{ω}{{ω}_{0}} )}^{- e} \qquad ( 9 )$$

where ω₀=v₀v (product between the spatial frequency of reference and the speed v) indicates the frequency of reference. It is to be noted how, in this example, the sole parameter which has to be fitting-determined results to be the amplitude S₀.

Another approximation, commonly used both for road and rail applications, easily usable since it requires the estimation of only two parameters, is the one proposed by Sussman [Andrén, DOI:10.1504/IJVD.2006.008450]. In the time-frequency domain ω, the pattern of the auto-PSD results to be

$${S}_{d ( Sus )} ( ω ) = \frac{c}{{ω}^{2} + {ω}_{0}^{2}} \qquad ( 10 )$$

where c (m²rad/s) and ω₀ (rad/s) are the unknown values to be determined.

In case in which the characterization concerns more parallel profiles, belonging to the same road surface or the two rails belonging to the same railway, the coherence function Γᵢⱼ(v) can be used to describe the relation therebetween. By considering two generic parallel profiles dᵢ(x) and dⱼ(x) posed at distance Wₘ and defined in function of the spatial abscissa x, such function can be computed by using the following formula:

$${Γ}_{m} ( v ) = \frac{\vert {S}_{{d}_{i} {d}_{j}} ( v ) \vert}{\sqrt{{S}_{{d}_{i}} ( v ) {S}_{{d}_{j}} ( v )}} \qquad ( 11 )$$

where the m-th trackwidth is the one individuated by the parallel profiles dᵢ(x) and dⱼ(x) and measures specifically the distance between such profiles. Moreover,
S_{d}_{ᵢ}(v) and S_{d}_{ⱼ}(v) are respectively the auto-PSDs associated to the profiles dᵢ(x) and dⱼ(x);
S_{d}_{ᵢ}_{d}_{ⱼ}(v) is the cross-PSD computed between the profiles dᵢ(x) and dⱼ(x).

It derives therefrom that the cross-PSD can be obtained as

S_{d}_{ᵢ}_{d}_{ⱼ}(v)=Γₘ(v)\sqrt{S_{d}_{ᵢ}(v)S_{d}_{ⱼ}(v)}e^{-iβ}^{ₘ}^{(v)} (12)

where βₘ(v) is the difference between the phases associated to the spectra of the two profiles dᵢ(x) and dⱼ(x). As a definition, the coherence is an even real function (Γₘ(v)=Γₘ(−v)) whose value can be between 0 and 1. As a consequence, two profiles result to be very similar with respect to each other only for such spatial frequencies that the coherence assumes values close to unit. Moreover, by bringing to zero the distance Wₘ between the two profiles, the coherence Γₘ(v) becomes clearly unitary. Studies carried out on different kinds of road/rail surfaces have shown how, in many cases, the coherence has a decreasing pattern in function of the spatial frequency v. The fitting model proposed by Bogsjö [Bogsjö, DOI:10.1080/00423110802018289] agrees well with such observations since it is based on the use of a decreasing exponetial function with only one parameter μ, according to the following relation

Γₘ(v)=e^{-μW}^{ₘ}^{|v|} (13)

Finally, it is to be remembered that since Γₘ(v) is a dimensionless unit, the relations reported in eqs. (11) and (13) can be converted in the time frequency domain ω applying the substitution v=ω/v.

Recently, the indirect characterization of the statistic properties of the road/rail surface profiles has had an increasing interest both in technical and Patent literature.

In particular, Gonzáles et al. [Gonzáles, DOI:10.1080/00423110701485050] propose a method for the indirect estimation of the auto-PSD of the road profile, in which the whole vehicle is considered in motion on a single profile. By knowing the matrix of FRFs of the vehicle, it is possible to reconstruct the auto-PSD of the profile starting from the sole accelerations detected on the same vehicle.

The application US 2014/257629 A1 describes a method to allow the estimation of the road profile starting from the vibrations measured upstream and downstream of one or more suspensions. Such method uses an algorithm based on an adaptive Kalman filter and referred to a mono-suspension model of vehicle.

The application US 2014/204205 A1 proposes a method for measuring the height of the road profiles on which a vehicle moves. Such method makes extensive use of the image processing techniques and requires the use of one or more cameras (for example cameras for traffic monitoring) arranged on the road level.

The methods proposed in the railway field are generally limited to detect the presence of faults of the rail and do not use algorithms of estimation to characterize the roughness statistic properties.

The application U.S. Pat. No. 799,988B2 describes a method for monitoring the railway network by means of at least a camera arranged on a rail vehicle. By means of algorithms of image controlling and modification it is possible to monitor the railway network and, above all, to detect the presence of possible anomalies on the same network.

The application U.S. Pat. No. 8,905,359 B2 describes a method for detecting rail damage. By using two accelerometers which measure the vertical and longitudinal acceleration of the axle respectively, it is possible to create a database of accelerometric signals. Possible damage can be identified as deviations between signals acquired in different times on the same railway section.

The application U.S. Pat. No. 8,942,426 B2 describes a method for monitoring the railway network in real time, by using cameras and GPS. The measurements are processed in real time to control if they respect criteria of irregularity presence of the railway network. If present, the data are sent automatically to a control centre to determine the kind of such irregularities.

### Technical Problem

In the specific case of OMA applied to a vehicle system, object of the present invention, it is certainly needed to verify if the following hypothesis of stationarity is satisfied:

hypothesis 6: the vehicle has to proceed in stationary running condition, i.e. at constant speed along a rectilinear trajectory or bend with constant radius, i.e. which does not imply abrupt variations of direction.

In these conditions, the vehicle is mainly subjected to stationary external loads, produced by the interactions existing between wheels and road/railway. Since, generally, the inlets applied to the system remain unknown, the operational modal analysis can be used to identify its modal parameters.

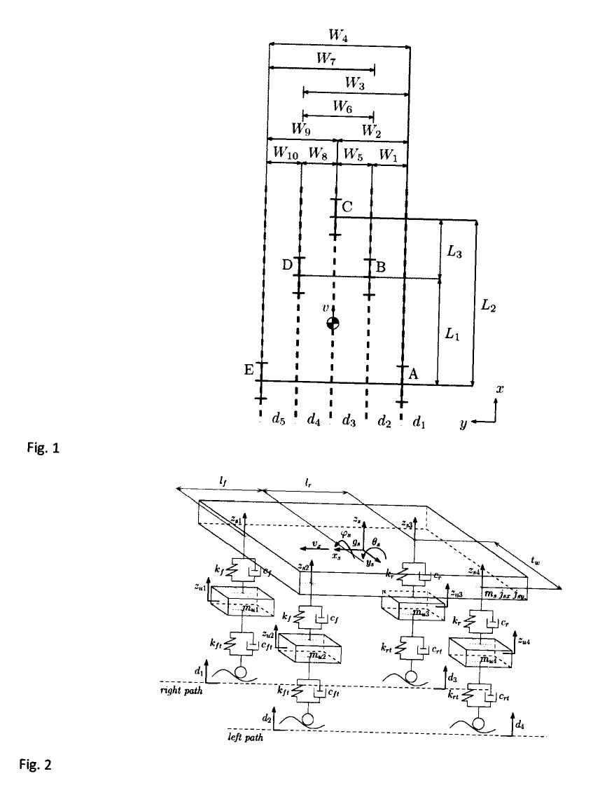

Let consider for example the vehicle described in FIG. (1) having a number of wheels Nₜ=5. The geometry was defined in such a way that it is general, thus resulting as being characterized by the presence of 10 trackwidths Wₘ and 3 different wheelbases Lₗ. In case in which the vehicle moves on 5 profiles d₁(x), . . . , d₅(x) in condition of stationary running with speed v, the external loads are transmitted to the system through each single wheel. For easiness, in order to describe its interactions with the rolling surface it is possible to consider a contact of punctiform kind. Since, in reality, the footprints act a slow-pass filter on the inlets, this mode of description can be introduced without loosing generality. If the hypotheses 3 to 6 were verified, the PSD matrix Sᵣ(ω), referred to the movements induced by the surface, on the wheels, in the respective contact points (indicated in FIG. 1 with letters A to E) could be defined in the time frequency domain ω as

$$\begin{matrix}{S}_{r} ( ω ) = [ \begin{matrix}{S}_{{d}_{A}} & {S}_{{d}_{A} {d}_{B}} & … & {S}_{{d}_{A} {d}_{E}} \\ {S}_{{d}_{A} {d}_{B}}^{*} & {S}_{{d}_{B}} & & ⋮ \\ ⋮ & & ⋱ & ⋮ \\ {S}_{{d}_{A} {d}_{E}}^{*} & … & … & {S}_{{d}_{E}}\end{matrix} ] ∈ {{N}_{i} \times {N}_{i}}^{} \\ = ⌊ \begin{matrix}{S}_{{d}_{1}} & {Γ}_{1} \sqrt{{S}_{{d}_{1}} {S}_{{d}_{2}}} {e}^{+ i ( ω {τ}_{1} - {β}_{1} )} & {Γ}_{2} \sqrt{{S}_{{d}_{1}} {S}_{{d}_{3}}} {e}^{+ i ( ω {τ}_{2} - {β}_{2} )} & {Γ}_{3} \sqrt{{S}_{{d}_{1}} {S}_{{d}_{4}}} {e}^{+ i ( ω {τ}_{1} - {β}_{3} )} & {Γ}_{4} \sqrt{{S}_{{d}_{1}} {S}_{{d}_{5}}} {e}^{- i {β}_{4}} \\ {S}_{{d}_{A} {d}_{B}}^{*} & {S}_{{d}_{2}} & {Γ}_{5} \sqrt{{S}_{{d}_{1}} {S}_{{d}_{3}}} {e}^{+ i ( ω {τ}_{3} - {β}_{5} )} & {Γ}_{6} \sqrt{{S}_{{d}_{2}} {S}_{{d}_{4}}} {e}^{- i {β}_{6}} & {Γ}_{7} \sqrt{{S}_{{d}_{2}} {S}_{{d}_{5}}} {e}^{- i ( ω {τ}_{1} + {β}_{7} )} \\ ⋮ & & {S}_{{d}_{3}} & {Γ}_{8} \sqrt{{S}_{{d}_{3}} {S}_{{d}_{4}}} {e}^{- i ( ω {τ}_{3} + {β}_{8} )} & {Γ}_{9} \sqrt{{S}_{{d}_{3}} {S}_{{d}_{5}}} {e}^{- i ( ω {τ}_{2} + {β}_{9} )} \\ ⋮ & & & {S}_{{d}_{4}} & {Γ}_{10} \sqrt{{S}_{{d}_{4}} {S}_{{d}_{5}}} {e}^{- i ( ω {τ}_{1} + {β}_{10} )} \\ {S}_{{d}_{A} {d}_{F}}^{*} & … & … & … & {S}_{{d}_{5}}\end{matrix} ⌋\end{matrix} \qquad ( 14 )$$

where τₗ=Lₗ/v with l=1, . . . , 3 indicates the generic lag between two axles, and for the sake of brevity, the dependence of S_{d}_{ᵢ}, Γₘ and βₘ on ω has been omitted. By indicating with H_{fr}(107 )∈ [symbol] ^{N}^{ᵢ}^{×N}^{ₗ} the matrix of the frequency response functions (FRF) of the wheels, the input PSD matrix S_{f}(ω), represented by the forces acting on the stocks, can be computed as

S_{f}(ω)=H*_{fr}(ω)Sᵣ(ω)H_{fr}^{T}(ω) (15)

Comparing the expressions of the input PSD matrix obtained by considering the natural excitation (eq. (2)) and the one due to the interaction with the rolling surface (eq. (15)), it is clear how the modal identification techniques deriving from the NExT hypotheses, and therefore based on the eqs. (5), (6) and (7), do not result valid in cases in which OMA is applied to vehicles in working condition. In fact: problem 1: the loads have a pattern which can be traced back to the one of the coloured noise, with an amplitude generally decreasing with frequency, whose form depends on the characteristics of the road/rail profile (eqs. (9) and (10)) and on the ones of the wheels (described by means of H_{fr}(ω) in eq. (15)): therefore the hypothesis 1 of NExT is not valid.

Problem 2: the inlets acting on the wheels positioned on the same axle are interested by spatial correlation (described by means of Γₘ(ω) in eq. (14)), the inputs applied on wheels having the rolling profile in common but arranged on different axles are interested by time correlation (described by means of e^{±iωτ}^{ₗ} in eq. (14)), while for the loads relating wheels with no rolling profile in common and belonging to different axles there is both a spatial and time correlation: therefore, the hypothesis 2 of NExT is not valid.

Therefore, the errors made in the estimation process by using models formulated according to the NExT hypotheses, increase remarkably. Moreover, to compensate errors of modelling, caused by the failed satisfaction of the NExT hypotheses, the known algorithms of identification introduce additional solutions which do not have physical meaning and which are provided in form of poles/spurious modes in the set of estimated modal parameters, which are difficult, if not impossible to be individuated and excluded. Therefore, a technical problem unsolved by the identification methods known at the state of the art, is to carry out the modal identification of a system also when this is subjected to “coloured” and correlated in time and space loads.

Therefore, a first aim of the present invention is to provide a method for the estimation of modal parameters of vehicles in working conditions, which considers explicitly the effects that the colouring and correlation of inlets have on the outputs of the system.

Referring to the indirect characterization of the road/rail surface profiles, the above-described methods and all the others known at the state of the art do not consider explicitly the effects of the correlation of the inlets on the outputs of the vehicle system. The method proposed by Gonzáles et al. [Gonzáles, DOI: 10.1080/00423110701485050] needs in fact a calibration step, needed to determine the matrix of FRFs of the vehicle in various working conditions, i.e. considering various travel speeds on a road surface with known features. The application US 2014/257629 A1 instead, proposes a method based on a mono-suspension model of vehicle which does not allow to consider properly the effects linked to the correlation of the road inlets.

Since the cameras are mounted on a fixed structure (and not on vehicles), the method described in the application US 2014/204205 A1 allows to reconstruct only the height of the profiles in the area covered by the angles of sight of the same cameras. In the railway field, the applications U.S. Pat. No. 799,988B2, U.S. Pat. No. 8,905,359 B2 and U.S. Pat. No. 8,942,426 B2 are limited to detect the presence of faults of the rail and do not use algorithms of estimation to characterize the statistic properties of roughness.

Therefore, according to another aim, the present invention provides a method for indirect characterization of the statistic properties of the road/rail surface profiles starting from the output signals acquired on vehicles in working conditions. In particular, by exploiting some intrinsic properties of homogeneity, the method proposed allows to reduce remarkably the number of quantities which it is needed to be estimated to characterize the statistic properties of parallel profiles belonging to the same rolling surface.

### BRIEF DESCRIPTION OF THE INVENTION

The present invention provides a method for the identification of the poles (λₙ) and modal vectors (ψₙ) of a road or rail vehicle provided with at least two wheels and in working condition, by means of the analysis of the movements or speeds or accelerations (output of the system) acquired in assigned measuring points of said vehicle, wherein said modal parameters are determined by means of the fitting of the data relating to said outputs of the system on the basis of a mathematical model which describes the interaction between road or railway and said vehicle, characterized by:
hypothesizing that said vehicle moves at constant speed on a rectilinear trajectory or bend with constant radius;
hypothesizing that said vehicle moves on a homogeneous and ergodic surface, whose roughness has a Gaussian distribution and that said at least two wheels move on a profile or on a plurality of profiles parallel with respect to each other;
hypothesizing that the inlets induced by the road or rail surface on said vehicle cannot be traced back to a sequence of white noises and are correlated with respect to each other in time and/or space.

Moreover, the present invention provides a method for the estimation of operational vectors (αₙ^{m}, βₙ^{ml} and χₙ^{ml}) and for the indirect characterization of the statistic properties of a road or rail surface obtained by using:

the auto-correlation function (R_{d}(τ)) or auto-PSD (S_{d}(ω)) associated to road or rail profiles;
the coherence functions (Γₘ(ω)) or respective IFTs (ηₘ(τ)) associated to parallel road or rail profiles.

### DETAILED DESCRIPTION OF THE INVENTION

In FIG. (1) it is shown the geometry of a vehicle with 5 wheels and having 10 trackwidths and 3 different wheelbases.

In FIG. (2) it is shown a schematized model of vehicle as system with 7 degrees of freedom.

In FIGS. (3.a) and (3.b) there are shown, respectively, the stabilization diagrams obtained by applying the procedure of identification according to the invention and the Least Square Complex Frequency domain (LSCF) algorithm to a model of vehicle with 7 degrees of freedom, in motion at constant speed (60 km/h) on a homogeneous and Gaussian surface.

In FIG. (4) it is shown a validation diagram of the synthetized model by using the proposed procedure of identification.

In FIGS. (5) to (8) there are shown some flowcharts explaining the method according to the present invention.

### BASIC HYPOTHESIS OF THE METHOD

The method for the modal identification of vehicles according to the present invention needs that all the hypotheses 3 to 6 are satisfied, but does not require that the NExT hypotheses 1 and 2 are satisfied: in other words, it is supposed that the surface is homogeneous and assimilable to an ergodic process, that roughness has a Gaussian distribution with null average and that the vehicle proceeds at constant speed along a rectilinear trajectory or bend with constant radius. But it is hypothesized that the loads acting on the vehicle have a pattern which can be traced back to the coloured noise and are interested by time and/or space correlation. In particular, as it is explained in the following, the knowledge of the geometry of the vehicle, intended as knowledge of trackwidths and wheelbases, allows to include information concerning the time and/or spatial correlation of the inlets in the modal identification method. This allows to determine the modal parameters of the vehicle and the characteristic parameters of the road/rail also in case in which the NExT hypotheses are not satisfied.

### Description of the Method

In case in which a given road or rail surface can be assimilated to a homogeneous Gaussian random field, the number of quantities needed to characterize the statistic properties associated to parallel profiles belonging thereto can be remarkably reduced. To such end, it is possible to exploit important intrinsic properties of homogeneity:

property 1: S_{d}_{ᵢ}(v)=S_{d}_{ⱼ}(v)=S_{d}(v), the auto-PSDs associated to the profiles dᵢ(x) and dⱼ(x) are coincident, and therefore they can be considered equal to a function S_{d}(v);

property 2: S_{d}_{ᵢ}_{d}_{ⱼ}(v)=Γₘ(v)S_{d}(v) the cross-PSD computed between the profiles dᵢ(x) and dⱼ(x) is a real function which depends exclusively on the auto-PSD S_{d}(v) and on the coherence function Γₘ(v).

Therefore, the PSD matrix of eq. (14), referred to the movements induced by the surface on the wheels, can be re-written in the domain of time frequency ω, as:

$$( 16 )$$

$${S}_{r} ( ω ) = {S}_{d} ( ω )$$

$$⌊ \begin{matrix}1 & {Γ}_{1} ( ω ) {e}^{+ i ω {τ}_{1}} & {Γ}_{2} ( ω ) {e}^{+ i ω {τ}_{2}} & {Γ}_{3} ( ω ) {e}^{+ i ω {τ}_{1}} & {Γ}_{4} ( ω ) \\ {Γ}_{1} ( ω ) {e}^{- i ω {τ}_{1}} & 1 & {Γ}_{5} ( ω ) {e}^{+ i ω {τ}_{3}} & {Γ}_{6} ( ω ) & {Γ}_{7} ( ω ) {e}^{- i ω {τ}_{1}} \\ ⋮ & & 1 & {Γ}_{8} ( ω ) {e}^{- i ω {τ}_{3}} & {Γ}_{9} ( ω ) {e}^{- i ω {τ}_{2}} \\ ⋮ & & & 1 & {Γ}_{10} ( ω ) {e}^{- i ω {τ}_{1}} \\ {Γ}_{4} ( ω ) & … & … & … & 1\end{matrix} ⌋$$

Knowing the geometry of the vehicle, in terms of trackwidths Wₘ and wheelbases Lₗ it is possible to compute the number of quantities to be known for the whole determination of the coefficients of the PSD matrix of eq. (16):
the number of auto-PSDs is limited to a single function S_{d};
the number of coherence function Γₘ coincides with the number of trackwidths N_{w};
the number of lags τₗ coincides with the number of wheelbases of different length N_{L}.

With reference to the generic vehicle system of FIG. (1), the input correlation matrix R_{f}(τ)∈ [symbol] ^{N}^{ᵢ}^{×N}^{ₗ} can be computed by applying the IFT to the expression of eq. (15); the output correlation matrix R_{q}(τ)∈ [symbol] ^{N×N} can be obtained by expressing firstly the response to the system to the action of arbitrary external loads, in the time domain, by using the so-called Duhamel's integral:

$$q ( t ) = {\int }_{- ∞}^{t} h ( t - ρ ) f ( ρ ) d ρ \qquad ( 17 )$$

Wherein h(t)∈ [symbol] ^{N×N} is the matrix of the response functions to the impulse, q(t)∈ [symbol] ^{N×l} is the output vector, f(t)∈ [symbol] ^{N×l} is the vector of the inlets, and by obtaining then the expression of the generic output cross-correlation function R_{q}_{ᵢ}_{q}_{ⱼ}(τ), considering two generic outputs qᵢ(t) and qⱼ(t). Such function comprises the parameters characteristic of the system dynamics (i.e. the modal parameters) and depends on the matrix R_{f}(τ).

It is specifically possible to demonstrate that the output correlation matrix R_{q}(τ) can be obtained in the following form:

$${R}_{q} ( τ ) = {\sum }_{n = 1}^{2 N} {\overline{ϕ}}_{n} ( τ ) {ψ}_{n}^{T} {e}^{{λ}_{n} τ} + {ψ}_{n} {\overline{ϕ}}_{n}^{T} ( - τ ) {e}^{- {λ}_{n} τ} \qquad ( 18 )$$

Where the terms φ̅ₙ(τ)∈ [symbol] ^{N×l} are lag-dependent operational reference vectors and are defined as

$${\overline{ϕ}}_{n} ( τ ) = {R}_{d} ( τ ) * ( {\sum }_{m = 0}^{{N}_{W}} {η}_{m} ( τ ) * ( {α}_{n}^{m} h ( τ ) + {\sum }_{l = 1}^{{N}_{L}} ( {β}_{n}^{m l} {e}^{+ {λ}_{n} {τ}_{l}} h ( τ + {τ}_{l} ) + {χ}_{n}^{m l} {e}^{- {λ}_{n} {τ}_{l}} h ( τ - {τ}_{l} ) ) ) ) \\ with {η}_{0} ( τ ) = 1 \qquad ( 19 )$$

### Where

R_{d}(τ) is the function of auto-correlation associated to the profiles and can be computed by means of the Inverse Fourier Transform, IFT, starting from S_{d}(ω);
ηₘ(τ) with m=1, . . . , N_{w} is the IFT of the coherence function Γₘ(107 ) computed between the profiles dᵢ and dⱼ arranged at distance Wₘ;
αₙ^{m}, βₙ^{ml} and χₙ^{ml}∈ [symbol] ^{N×l} are the operational vectors.

As a consequence, the expression of the output PSD matrix S_{q}(ω) can be obtained by eq. (18) by applying the Fourier Transform

$${S}_{q} ( ω ) = {\sum }_{n = 1}^{2 N} \frac{{ϕ}_{n} ( ω ) {ψ}_{n}^{T}}{i ω - {λ}_{n}} + \frac{{ψ}_{n} {ϕ}_{n}^{T} ( - ω )}{- i ω - {λ}_{n}} \qquad ( 20 )$$

Where the terms φₙ(ω)∈ [symbol] ^{N×l} are the frequency-dependent operational reference vectors and are defined as

$${ϕ}_{n} ( ω ) = {S}_{d} ( ω ) ( {\sum }_{m = 0}^{{N}_{W}} {Γ}_{m} ( ω ) ( {α}_{n}^{m} + {\sum }_{l = 1}^{{N}_{L}} {β}_{n}^{m l} {e}^{+ i ω {τ}_{l}} + {χ}_{n}^{m l} {e}^{- i ω {τ}_{l}} ) ) \\ with {Γ}_{0} ( ω ) = 1 \qquad ( 21 )$$

By grouping the various terms, eq. (20) can be re-written in more general form, as ratio between polynomial functions

$${S}_{q} ( ω ) = \frac{\begin{matrix}{S}_{d} ( ω ) ( {\sum }_{m = 0}^{{N}_{W}} {Γ}_{m} ( ω ) ( {B}^{m} ( ω ) + {\sum }_{l = 1}^{{N}_{L}} ( {C}^{ml} ( ω ) {e}^{+ i ω {τ}_{l}} + \\ {D}^{ml} ( ω ) ( {e}^{- i {ωτ}_{l}} ) ) )\end{matrix}}{A ( ω )} \qquad ( 22 )$$

### Where

B^{m}(ω), C^{ml}(ω) and D^{ml}(ω)∈ [symbol] ^{N×N} represent matrices whose generic elements

$${B}_{ij}^{m} ( ω ) = {\sum }_{r = 0}^{{n}_{b}} {( i ω )}^{r} {b}_{ijr}^{m} , {C}_{ij}^{ml} ( ω ) = {\sum }_{r = 0}^{{n}_{b}} {( i ω )}^{r} {c}_{ijr}^{ml} and {D}_{ij}^{ml} ( ω ) = {\sum }_{r = 0}^{{n}_{b}} {( i ω )}^{r} {d}_{ijr}^{ml}$$

are numerator polynomials of the corresponding PSD, having coefficients bᵢⱼᵣ^{m}, cᵢⱼᵣ^{ml} and dᵢⱼᵣ^{ml}, respectively; the polynomials Bᵢⱼ^{m}(ω), Cᵢⱼ^{ml}(ω) and Dᵢⱼ^{ml}(ω) are here called fitting polynomials and result to be associated to the inputs.

$$- A ( ω ) = {\sum }_{r = 0}^{{n}_{a}} {( i ω )}^{r} {a}_{r}$$

is the denominator polynomial, common to all the PSD, having coefficients aᵣ; it represents the characteristic polynomial whose roots are the system poles;

n_{b} and nₐ indicate the number of coefficients of numerator and denominator polynomials, respectively.

Therefore, it is clear that eqs. (18) to (22) contain a combination of various terms therein:

(i) R_{d}(τ) and S_{d}(ω) describe in the separation and frequency domain, respectively, the pattern of the statistic properties associated to the profiles;

(ii) h(τ±τₗ) and e^{±iωτ}^{ₗ} allow to include the effects of the time correlation existing between the inlets acting on the wheels having the rolling profile in common but arranged on different axles;

(iii) ηₘ(τ) and Γₘ(ω) model the effects of the spatial correlation existing between the inlets acting on wheels in motion on different profiles.

Finally, said equations underlie a new method for identification of vehicles in working conditions. Starting from these expressions, it is possible to develop specific procedures which allow the estimation of modal parameters of road/rail vehicle systems in working condition and the indirect characterization of statistic properties of the road/rail surface profiles. In particular, eqs. (18) to (19) can be used to set the algorithms operating in the separation domain.

As an alternative, according to a preferred embodiment of the invention, by using eqs. (20), (21) and (22) it is possible to implement fitting techniques able to exploit the advantages deriving from the analysis of the frequency domain.

### Procedure of Identification in the Frequency Domain

The procedure of identification, object of the present invention, requires that the geometry of the vehicle system is known in number and dimension of trackwidths and wheelbases. It is sufficient to measure the sole output signals. The measuring tools can concern various quantities, for example movements, speed or accelerations acquired in assigned measuring points of said vehicle. Even if it is known that, even using only one measuring tool, it is possible to identify all the modal parameters of the system, in order to obtain a suitable visual reconstruction of the modal forms and therefore, a good spatial resolution of the same, it is recommended to use a suitable number of sensors. A suitable experimental setup can be realized by positioning the sensors upwards or downwards of each suspension. To initialize the process of estimation it can be useful to detect the position and the speed of the vehicle on the tract covered by using for example a GPS sensor. Such information can allow to discriminate possible transitory zones during which the stationary running condition is not respected. Once the signals are acquired, the real data analysis step begins.

Even if the method according to the present invention can be applied also in the separation domain, by adopting a method working in the frequency domain at least three advantages are obtained: (1) minimum computational effort; (ii) clearer stabilization diagrams and (iii) capacity of the method to treat correctly strongly damped systems as the vehicle systems are generally.

The procedure of estimation according to this embodiment of the invention is divided in two steps:
step A: estimation of the poles and modal vectors of the vehicle system;
step B: estimation of the operational vectors and characteristic parameters of road/railway.

It is to be said that the step A, estimation of the poles and modal vectors of the vehicle, comprises the following steps:

A.1) estimation of one of more functions of the output PSD matrix S_{q}(ω) starting from the output signals measured on the basis of the polynomial model expressed by means of eq. (25) represented in the following;

A.2) estimation of the poles λₙ and modal vectors ψₙ by determining the auto-values and auto-vectors of the companion matrix associated to the characteristic polynomial of eq. (25).

The step B, estimation of operational vectors and characteristic parameters of road/railway, comprises the following steps:

B.1) choice of the parametric model to be used to describe the auto-PSD associated to the road profiles S_{d}(ω) and, when present, the coherence functions Γₘ(ω);

B.2) estimation of the operational vectors αₙ^{m}, βₙ^{ml} and χₙ^{ml}, of the parameters of the auto-PSD associated to the road profiles S_{d}(ω) and, if required, of the parameters of the coherence functions Γₘ(ω) on the basis of the decomposition in simple fractions of one or more functions of the output PSD matrix S_{q}(ω) according to eqs. (26) to (34) represented in the following.

The procedure of identification of the modal parameters is described in the following in detail in single steps and with reference to the use of a polynomial basis function Ωᵣ(ω). The polynomial function Ωᵣ(ω) can be Ωᵣ(ω)=(iω)^{r} for models in the continuous time domain and Ωᵣ(ω)=(e^{iωT}^{ₛ})^{r} for the models in discrete time domain, where Tₛ indicates the sampling period.

### Step A: Estimation of the Poles and Modal Vectors of the Vehicle System

During step A, as above described, the poles λₙ and modal vectors ψₙ of the vehicle systems are determined starting from the sole output signals. The step A comprises the following two steps:

A.1) estimation of one or more functions of the output PSD matrix S_{q}(ω) starting from output signals measured on the basis of the polynomial model expressed by the following eq. (25).

The algorithms through which it is possible to determine output auto- and cross-PSD are parametric estimators, since they require the adoption of a data fitting model. In this contest, the parametric estimators can be divided in two kinds: (i) parametric estimators in the strict sense of the word: if the starting data on which the parametric estimator works are the measured signals; (ii) mixed parametric estimators: if the starting data on which the parametric estimator works are the non-parametric estimations of PSDs.

In particular, the non-parametric estimations of PSDs can be obtained starting from the theoretical definition of PSD, for example according to the Parseval's and Wiener-Khinchin's theorems. What usually differentiates such estimators is the domain of the data on which they work and the windows used in order to reduce the estimation errors, for example, the leakage. Welch's Weighted Periodogram Method and Correlogram Method are to be mentioned among the most diffused techniques in the contest of OMA.

In particular, in the method according to the present invention, a simplification of the polynomial model of eq. (22) is obtained by describing the pattern of the auto-PSD associated to profiles S_{d} and the one of the coherence functions Γₘ by means of a polynomial model with sole zeros which, clearly, does not introduce poles in the output PSD and, as a consequence, does not influences the estimation of the poles of the systems and its modal vectors.

On the basis of such consideration it is possible to write:

$$\begin{matrix}{S}_{d} ( ω ) = {\sum }_{r = 0}^{{n}_{s}} {Ω}_{r} ( ω ) {σ}_{r} & ( 23 ) \\ {Γ}_{m} ( ω ) = {\sum }_{r = 0}^{{n}_{g}} {Ω}_{r} ( ω ) {γ}_{r}^{m} & ( 24 )\end{matrix}$$

where
σᵣ and nₛ indicate the coefficients and the number of coefficients of the interpolator polynomial of the auto-PSD associated to the profiles, respectively;
γᵣ and n_{g} indicate the coefficients and the number of coefficients of the interpolator polynomials of the coherence functions, respectively.

On the basis of the fitting model presented in eq. (22) and by exploiting the eqs. (23) and (24), the new polynomial model of the output PSD matrix S_{q}(ω) becomes

$${S}_{q} ( ω ) = \frac{\overline{B} ( ω ) + {\sum }_{l = 1}^{{N}_{L}} ( {\overline{C}}^{l} ( ω ) {e}^{+ i ω {τ}_{l}} + {\overline{D}}^{l} ( ω ) {e}^{- i ω {τ}_{l}} )}{A ( ω )} \qquad ( 25 )$$

### Where

B̅(ω), C̅^{l}(ω) and D̅^{l}(ω)∈ [symbol] ^{N×N} represent matrices whose generic elements

$${\overline{B}}_{ij} ( ω ) = {\sum }_{r = 0}^{{n}_{b}} {Ω}_{r} ( ω ) {\overline{b}}_{ijr} , {\overline{C}}_{ij}^{l} ( ω ) = {\sum }_{r = 0}^{{n}_{b}} {Ω}_{r} ( ω ) {\overline{c}}_{ijr}^{l} and {\overline{D}}_{ij}^{l} ( ω ) = {\sum }_{r = 0}^{{n}_{b}} {Ω}_{r} ( ω ) {\overline{d}}_{ijr}^{l}$$

are the numerator polynomials of the corresponding PSD, having coefficients , b̅ᵢⱼᵣ, c̅ᵢⱼᵣ^{l} and d̅ᵢⱼᵣ^{l} Jᵤ^{l} respectively. It is to be underlined that, by virtue of the estimation method chosen, the coefficients b̅ᵢⱼᵣ, c̅ᵢⱼᵣ^{l} and d̅ᵢⱼᵣ^{l} comprise the piece of information relative to the colourization of the inlets and to the spatial correlation therebetween.

$$- A ( ω ) = {\sum }_{r = 0}^{{n}_{g}} {( i ω )}^{r} {a}_{r}$$

is the denominator polynomial, common to all the PSDs, having coefficients aᵣ.

The determination of the unknown values of eq. (25) needs that an estimation problem is solved. Such problem can be set such that it results liner- or non-linear-in-the-parameters. According to the cases, the unknown values can be calculated by means of techniques known in literature, for example, by reducing at minimum the square error (Least Squares approach) or maximizing the likelihood function (Maximum Likelihood approach) and, by using, where it is possible, direct solving methods (for example based on the inversion of a known regression matrix) or iterative methods (for example based on the Newton-Raphson or Levenberg-Marquardt resolution algorithms).

A.2) estimation of poles λₙ and modal vectors ψₙ by determining the eigen-values and aeigen-vectors of the companion matrix associated to the characteristic polynomial of eq. (25).

Once the coefficients of the numerator and denominator polynomials of eq. (25) are estimated it is possible to convert the polynomial model in a standard representation in the State Space, by constructing the companion matrix of the characteristic polynomial A(ω). Independently of the representation used, said matrix corresponds to the state matrix, whose eigen-values are the system poles λₙ by definition. Instead, the eigen-vectors associated to such matrix can assume various physical meanings according to the standard form used. Therefore, the representation in State Space has to be chosen such that the modal vectors ψₙ correspond to such eigen-vectors.

### Step B: Estimation of the Operational Vectors and Characteristic Parameters of Road/Rail

During step B, as above described, the operational vectors and the characteristic parameters of road/railway are obtained. The step B comprises the following steps:

B.1) description of the auto-PSD associated to profiles S_{d}(ω) and, if present, of the coherence functions Γₘ(ω), by means of a suitably chosen parametric model.

To such end, the polynomial models with sole zeros introduced in eqs. (23) and (24) can be used, anyway their use implies the presence of a high number of unknown parameters to be estimated. On the contrary, the models proposed at the state of the art of the present description offer the advantage that they are characterized by a very much smaller number of parameters and result well corresponding to the typical patterns observed in the experimental measurements. To carry out such simplification, as a way of example, the models proposed by Sussman (eq. (10)) and Bogsjö (eq. (13)) in the time frequency domain ω are considered.

B.2) Estimation of the operational vectors αₙ^{m}, βₙ^{ml} and χₙ^{ml} of the parameters of the auto-PSD associated to profiles S_{d}(ω) and, if required, of the parameters of the coherence functions Γₘ(ω), on the basis of the decomposition in simple fractions of one or more functions of the output PSD matrix S_{q}(ω), according to the following eqs. (26) to (34).

Starting from the decomposition in simple fractions of the output PSD matrix S_{q}(ω) (Eq. (20)) the generic auto-PSD S_{q}_{ᵢ}(ω) can be expressed as:

$${S}_{{q}_{i}} ( ω ) = {\sum }_{n = 1}^{2 N} \frac{{ϕ}_{in} ( ω ) {ψ}_{in}}{{Ω}_{1} ( ω ) - {λ}_{n}} + \frac{{ψ}_{in} {ϕ}_{in} ( - ω )}{{Ω}_{1} ( - ω ) - {λ}_{n}} \qquad ( 26 )$$

Where the i-th components of the operational vectors dependent on the frequency φᵢₙ(ω) are given by:

$${ϕ}_{in} ( ω ) = {S}_{d} ( ω ) {\sum }_{m = 0}^{{N}_{W}} {Γ}_{m} ( ω ) ( {α}_{in}^{m} + {\sum }_{l = 1}^{{N}_{L}} ( {β}_{in}^{ml} {e}^{+ i {ωτ}_{l}} + {χ}_{in}^{ml} {e}^{- {ωτ}_{l}} ) ) with {Γ}_{0} ( ω ) = 1 \qquad ( 27 )$$

Using the models proposed by Sussman (Eq. (10)) and Bogsjö (eq. (13)) in the time frequency domain ω, eq. (27) can be re-written as:

$${ϕ}_{in} ( ω ) = \frac{c}{{ω}^{2} + {ω}_{0}^{2}} {\sum }_{m = 0}^{{N}_{W}} {e}^{- \frac{{μ}_{m} {W}_{m} \vert ω \vert}{v}} ( {α}_{in}^{m} + {\sum }_{l = 1}^{{N}_{L}} ( {β}_{in}^{ml} {e}^{+ i ω {τ}_{l}} + {χ}_{in}^{ml} {e}^{- i ω {τ}_{l}} ) ) with {μ}_{0} {W}_{0} = 0 \qquad ( 28 )$$

As a consequence eq. (26) becomes:

$${S}_{{q}_{i}} ( ω ) = \frac{c}{{ω}^{2} + {ω}_{0}^{2}} {\sum }_{n = 1}^{2 N} ( {\sum }_{m = 0}^{{N}_{W}} {e}^{- \frac{{μ}_{m} {W}_{m} \vert ω \vert}{v}} ( {T}_{in} ( ω ) {α}_{in}^{m} + {\sum }_{l = 1}^{{N}_{L}} ( {U}_{in}^{l} ( ω ) {β}_{in}^{ml} + {V}_{in}^{l} ( ω ) {χ}_{in}^{ml} ) ) ) with {μ}_{0} {W}_{0} = 0 \qquad ( 29 )$$

where

$$\begin{matrix}{T}_{in} ( ω ) = \frac{{ψ}_{in}}{{Ω}_{1} ( ω ) - {λ}_{n}} + \frac{{ψ}_{in}}{{Ω}_{1} ( - ω ) - {λ}_{n}} & ( 30 ) \\ {U}_{in}^{l} ( ω ) = \frac{{ψ}_{in} {e}^{+ i {ωτ}_{l}}}{{Ω}_{1} ( ω ) - {λ}_{n}} + \frac{{ψ}_{in} {e}^{- i {ωτ}_{l}}}{{Ω}_{1} ( - ω ) - {λ}_{n}} & ( 31 ) \\ {V}_{in}^{l} ( ω ) = \frac{{ψ}_{in} {e}^{- i {ωτ}_{l}}}{{Ω}_{1} ( ω ) - {λ}_{n}} + \frac{{ψ}_{in} {e}^{+ i {ωτ}_{l}}}{{Ω}_{1} ( - ω ) - {λ}_{n}} & ( 32 )\end{matrix}$$

In particular, the unknown values in eq. (29) are:
the i-th components of the operational vectors αᵢₙ^{m}, βᵢₙ^{ml} and χᵢₙ^{ml} with m=0, . . . , N_{W}, l=1, . . . , N_{L}, n=1, . . . , 2N;
the parameters c and ω₀ of the auto-PSD associated to profiles S_{d}(ω);
the parameters μₘ with m=1, . . . , N_{W} of the coherence functions Γₘ(ω).

The determination of the unknown values of eq. (29) needs the solution of problem of non-linear-in-parameters estimation.

In particular, the parameters needed for the characterization of the rolling surface can be initialized by using data coming from experimental measurements or values known in literature.

It is possible to individuate three cases in which the estimation of parameters of the coherence functions Γₘ(ω) is not required:

Case 1: if a vehicle is in motion on a single profile, for example a motorbike, the Γₘ(ω)are not present;

case 2: if a vehicle is in motion on perfectly coincident profiles, the coherence functions are known and assume all a value equal to 1;

case 3: if a vehicle is in motion on completely different profiles, the coherence functions are known and assume all a value equal to 0.

In all the three cases, the determination of the unknown values can be obtained by using the following relation, derived starting from eq. (29):

$${S}_{{q}_{i}} ( ω ) = \frac{c}{{ω}^{2} + {ω}_{0}^{2}} {\sum }_{n = 1}^{2 N} ( {T}_{in} ( ω ) {α}_{in} + {\sum }_{l = 1}^{{N}_{L}} ( {U}_{in}^{l} ( ω ) {β}_{in}^{l} + {V}_{in}^{l} ( ω ) {χ}_{in}^{l} ) ) \qquad ( 33 )$$

In particular, the unknown values of eq. (33) are:
the i-th components of the operational vectors αᵢₙ, βᵢₙ^{l} and χᵢₙ^{l} with l=1, . . . , N_{L}, n=1, . . . , 2N;
the parameters c and ω₀ of the auto-PSD associated to profiles S_{d}(ω).

Unlike eq. (29), the determination of the unknown values of eq. (33) can be carried out by solving a problem of linear-in-parameters estimation.

The estimation of the remaining components of the operational vectors αₙ, βₙ^{l} and χₙ^{l} in the case in which the coherence functions are not required, or αₙ^{m}, βₙ^{ml} and χₙ^{ml} in the opposite case, can be obtained by following the same procedure previously described, in the present section, and by considering the partial fraction decomposition of the generic output cross-PSD S_{q}_{ᵢ}_{q}_{ⱼ}(ω)

$${S}_{{q}_{i} {q}_{j}} ( ω ) = {\sum }_{n = 1}^{2 N} \frac{{ϕ}_{in} ( ω ) {ψ}_{jn}}{{Ω}_{1} ( ω ) - {λ}_{n}} + \frac{{ψ}_{in} {ϕ}_{jn} ( - ω )}{{Ω}_{1} ( - ω ) - {λ}_{n}} \qquad ( 34 )$$

In such case, the only unknown values to be estimated in eq. (34) will be the i-th components of the operational vectors αⱼₙ, βⱼₙ^{l} and χⱼₙ^{l} with l=1, . . . , N_{L}, n=1, . . . , 2N, or αⱼₙ^{m}, βⱼₙ^{ml} and χⱼₙ^{ml} with m=0, . . . , N_{W}, l=1, . . . , N_{L} and n=1, . . . , 2N.

### NUMERICAL EXAMPLE

To show the performance of the procedure of identification, object of the present invention, in the following a numerical example of identification of a vehicle system is described, with concentrated parameters, with 7 degrees of freedom (DOFS, degree of freedom), represented in FIG. (2). The motion of a vehicle with geometrical features and known modal parameters on a surface which respects the hypothesis of the method according to the present invention was simulated in a suitable computing field. The model used allows to describe the modes of rigid body of the suspended mass (the chassis), i.e. heave, pitch and roll, and the modes of the rigid body of the non-suspended masses (the wheels), i.e. vertical shaking and roll motions of front and rear axles. The natural frequencies fₙ=ωₙ/2π (Hz) and the damping factors ζₙ (%) are reported in the following table:

| Mode | fₙ (Hz) | ζₙ (%) | Description |
|---|---|---|---|
| 1 | 1.064 | 27.954 | Heave |
| 2 | 1.221 | 32.189 | Roll |
| 3 | 1.295 | 34.295 | Pitch |
| 4 | 8.044 | 26.031 | rear axle hop |
| 5 | 8.129 | 27.794 | front axle roll |
| 6 | 8.134 | 28.372 | front axle hop |
| 7 | 8.207 | 25.354 | rear axle roll |

The vehicle has a known geometry, with only one trackwidth W₁=1.49 m and only one wheelbase L₁=2.66 m, and it is supposed that it is in motion at constant speed v=60 km/h on an homogeneous and Gaussian surface (see hypotheses 3 to 6).

The modes of the rigid body have been captured by using a layout of virtual movement sensors, arranged along the vertical directions in the 3 angles of the suspended mass (zₛ_{₁}, zₛ_{₂} and zₛ_{₃}) and on each one of the 4 non-suspended masses (zᵤ_{₁}, zᵤ_{₂}, zᵤ_{₃} and zᵤ_{₄}): the time series of data relative to these seven movement sensors are the only data used as input for the method of identification. The same data, as described in the following, have been analysed with a traditional OMA technique (LSCF) and with the method according to the present invention.

In this example to describe the inlets produced by the interaction between wheels and rolling profiles, by means of eq. (16), there are needed;
only one coherence function Γ₁(ω), computed between the profiles d₁ and d₂, on which the wheels of right and left side roll, respectively;
only one lag τ₁=0.16 s.

Such inlets are simulated by using as parametric models the ones proposed by Sussman (eq. (10)) for the auto-PSD associated to profiles S_{d}(ω), and by Bogsjö (eq. (13)) for the coherence function Γ₁(ω). The parameters used are collected in the following table:

| | |
|---|---|
| Sussman Model | Bogsjö Model |

| c (m²rad/s) | ω₀ (rad/s) | μ₁ |
|---|---|---|
| 0.122 | 1.96 | 3.80 |

Finally, the output signals are computed in terms of auto- and cross-PSD by means of the inlet-output relation of eq. (17).

To underline the problems deriving from the use of the usual algorithms of classic OMA, i.e. based on the NExT hypotheses (eqs. (5), (6) and (7)), the same output signals are processed by means of the LSCF estimator and the respective results are compared with the ones obtained by using the algorithm, object of the present invention.

In the modal testing, the stabilization analysis is often used to assist the analyst in the choice of the physical poles of the system. The presence of spurious poles, in fact, can influence the process of estimation more or less strongly. Their presence can be attributed to various causes, for example the noise in the data, modelling errors and computational problems. The physical poles, instead, tend to be stabilized when the estimation is carried out with various polynomial orders.

A graphical tool, called stabilization diagram, allows to visualize the modal parameters estimated with increasing orders of the polynomial. The natural frequencies are represented on the axis of abscissae while the various orders are reported on the axis of ordinates. The analyst sets the tolerance thresholds which define the stabilization on the natural frequency, on the damping factor and on the value of the Modal Assurance Criterion (MAC). The various situations are represented with different symbols: the o indicates the failed stabilization of the natural frequency, the f represents the stabilization of the natural frequency, the d and v represent the extra stabilization on the damping factor and modal vector, the s refers to the wholly stabilized solutions.

In FIGS. (3.a) and (3.b) the stabilization diagrams are reported, obtained by using the proposed procedure of identification (eq. (25)) and the LSCF algorithm, respectively. The curve on the background refers to the auto-PSD calculated starting from the movements detected by the sensor arranged on the frontal right part of the suspended mass (zₛ_{₁} in FIG. 2)). It is to be noted how the solutions produced by the LSCF algorithm tend to not stabilize even to high polynomial orders, thus producing also a remarkable quantity of poles/spurious modes. The proposed procedure of identification instead, provides a very clear stabilization diagram, where the columns of wholly stabilized solutions and corresponding to the 7 poles/physical modes of the system appear clear. The natural frequencies fₙ (Hz), the damping factors ζₙ (%) obtained by using a polynomial order equal to 40, are given in the following table:

| Mode | fₙ (Hz) | ζₙ (%) |
|---|---|---|
| 1 | 1.064 | 27.862 |
| 2 | 1.222 | 32.189 |
| 3 | 1.294 | 34.319 |
| 4 | 8.044 | 26.031 |
| 5 | 8.129 | 27.794 |
| 6 | 8.134 | 28.368 |
| 7 | 8.207 | 25.354 |

From the analysis of the above introduced tables it can be noted how the estimations provided by the proposed procedure of identification agree perfectly with the exact values both in terms of natural frequencies and damping factors.

In this contest, MAC can be used to compare the modal vectors (ψₙ) estimated with the exact ones. In particular, such matrix allows to quantify the resemblance between modal vectors of sets of various modes, by varying from 1, whole correlation, to 0, exact orthogonality. Therefore the ideal solution is the one in which MAC coincides with the so-called auto-MAC obtained by comparing modal vectors belonging to the same set of modes with themselves. The matrix of auto-MAC referred to the exact modal vectors of the vehicle system of FIG. (2) is reported in the following:

| | | Exact Modal Vectors | | | | | | |
|---|---|---|---|---|---|---|---|---|
| | | 1 | 2 | 3 | 4 | 5 | 6 | 7 |
| Exact Modal | 1 | 1.000 | 0.011 | 0.019 | 0.001 | 0.000 | 0.021 | 0.000 |
| Vectors | 2 | 0.011 | 1.000 | 0.291 | 0.003 | 0.024 | 0.000 | 0.007 |
| | 3 | 0.019 | 0.291 | 1.000 | 0.032 | 0.002 | 0.003 | 0.001 |
| | 4 | 0.001 | 0.003 | 0.032 | 1.000 | 0.000 | 0.030 | 0.000 |
| | 5 | 0.000 | 0.024 | 0.002 | 0.000 | 1.000 | 0.000 | 0.365 |
| | 6 | 0.021 | 0.000 | 0.003 | 0.030 | 0.000 | 1.000 | 0.000 |
| | 7 | 0.000 | 0.007 | 0.001 | 0.000 | 0.365 | 0.000 | 1.000 |

While MAC computed between the estimated and exact modal vectors is:

| | | Estimated Modal Vectors | | | | | | |
|---|---|---|---|---|---|---|---|---|
| | | 1 | 2 | 3 | 4 | 5 | 6 | 7 |
| Exact Modal | 1 | 1.000 | 0.011 | 0.018 | 0.001 | 0.000 | 0.021 | 0.000 |
| Vectors | 2 | 0.011 | 1.000 | 0.291 | 0.003 | 0.024 | 0.000 | 0.007 |
| | 3 | 0.019 | 0.291 | 1.000 | 0.032 | 0.002 | 0.003 | 0.001 |
| | 4 | 0.001 | 0.003 | 0.032 | 1.000 | 0.000 | 0.030 | 0.000 |
| | 5 | 0.000 | 0.024 | 0.002 | 0.000 | 1.000 | 0.000 | 0.365 |
| | 6 | 0.021 | 0.000 | 0.003 | 0.027 | 0.000 | 0.999 | 0.000 |
| | 7 | 0.000 | 0.007 | 0.001 | 0.000 | 0.365 | 0.000 | 1.000 |

The MAC obtained by the proposed procedure of identification is very close to the ideal situation, thus showing the exactness of the estimated modal vectors.

To complete the estimation of the modal parameters it is now needed to determine the operational vectors (αₙ^{m}, βₙ^{ml} and χₙ^{ml}). To such aim, by means of eqs. (26) to (33) it is to be computed firstly the coefficients associated to the parametric models of the auto-PSD associated to profiles S_{d}(ω) and of the coherence function Γ₁(ω). The results, reported in the following table, show an optimum correspondence to the exact values, used to model the inlets produced by the interaction of the wheels with the rolling profiles:

| | |
|---|---|
| Sussman Model | Bogsjö Model |

| c (m²rad/s) | ω₀ (rad/s) | μ₁ |
|---|---|---|
| 0.119 | 1.96 | 3.64 |

At this point, it is possible to determine all the components of the operational vectors, referring time by time to an output auto- or cross-PSD and using eqs. (26) or (34). Again, MAC can be used to compare the estimated operational vectors with the exact ones. For briefness, the matrix of the auto-MAC reported in the following refers to a sub-set of the exact operational vectors of the vehicle system of FIG. (2):

| | | Ex. Op. Vects. | | | | | | |
|---|---|---|---|---|---|---|---|---|
| | | 1 | 2 | 3 | 4 | 5 | 6 | 7 |
| Ex. Op. Vects. | 1 | 1.000 | 0.002 | 0.009 | 0.028 | 0.000 | 0.491 | 0.000 |
| | 2 | 0.002 | 1.000 | 0.046 | 0.001 | 0.502 | 0.000 | 0.140 |
| | 3 | 0.009 | 0.046 | 1.000 | 0.664 | 0.001 | 0.059 | 0.000 |
| | 4 | 0.028 | 0.001 | 0.664 | 1.000 | 0.000 | 0.030 | 0.000 |
| | 5 | 0.000 | 0.502 | 0.001 | 0.000 | 1.000 | 0.000 | 0.366 |
| | 6 | 0.491 | 0.000 | 0.059 | 0.030 | 0.000 | 1.000 | 0.000 |
| | 7 | 0.000 | 0.140 | 0.000 | 0.000 | 0.366 | 0.000 | 1.000 |

While MAC computed between the estimated and the exact operational values is:

| | | Estimated Op. Vects. | | | | | | |
|---|---|---|---|---|---|---|---|---|
| | | 1 | 2 | 3 | 4 | 5 | 6 | 7 |
| Ex. Op. Vects. | 1 | 1.000 | 0.002 | 0.009 | 0.031 | 0.000 | 0.499 | 0.000 |
| | 2 | 0.002 | 1.000 | 0.046 | 0.001 | 0.536 | 0.000 | 0.149 |
| | 3 | 0.009 | 0.048 | 1.000 | 0.680 | 0.001 | 0.064 | 0.000 |
| | 4 | 0.030 | 0.001 | 0.683 | 1.000 | 0.000 | 0.032 | 0.000 |
| | 5 | 0.000 | 0.530 | 0.001 | 0.000 | 1.000 | 0.000 | 0.393 |
| | 6 | 0.520 | 0.000 | 0.062 | 0.032 | 0.000 | 0.991 | 0.000 |
| | 7 | 0.002 | 0.146 | 0.110 | 0.010 | 0.372 | 0.000 | 1.000 |

Again, the MAC obtained from the proposed procedure of identification is very close to the ideal situation, thus showing the exactness of the estimated operational vectors.

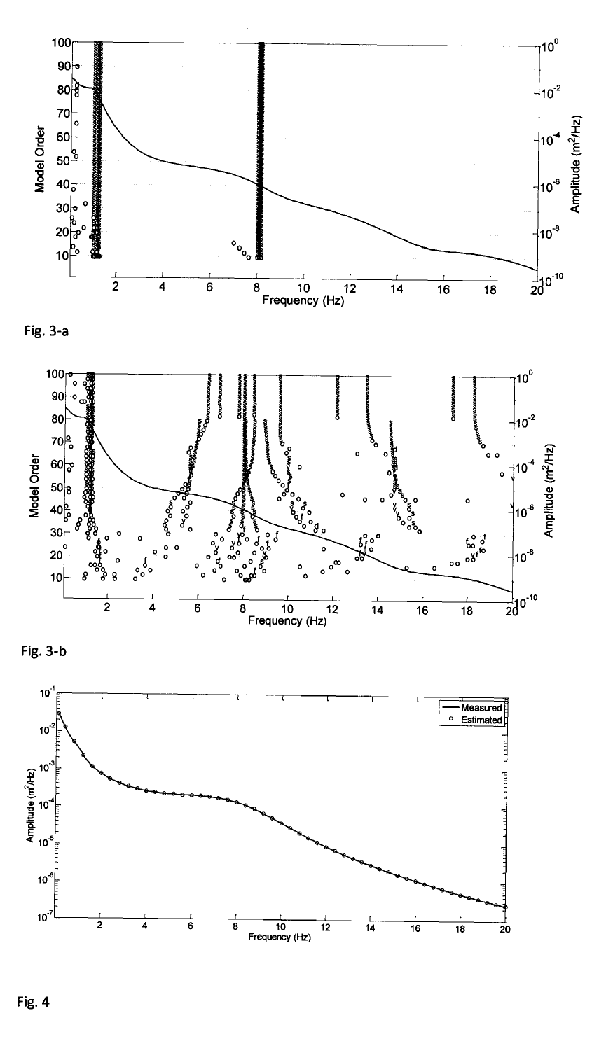

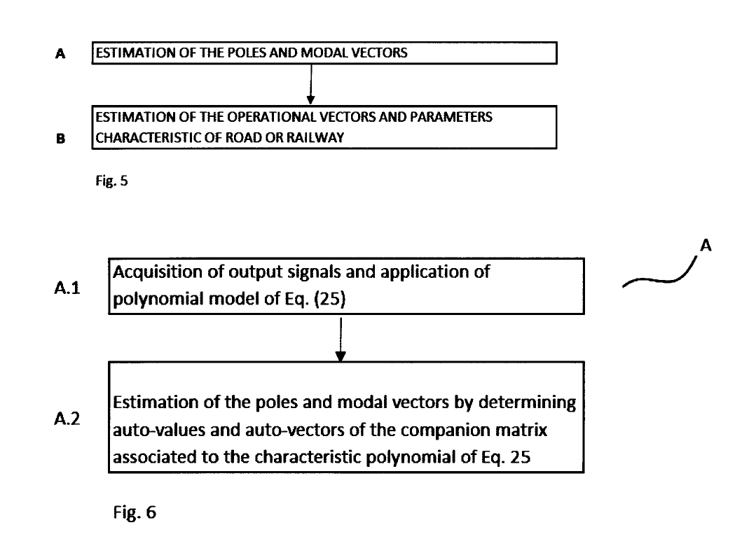

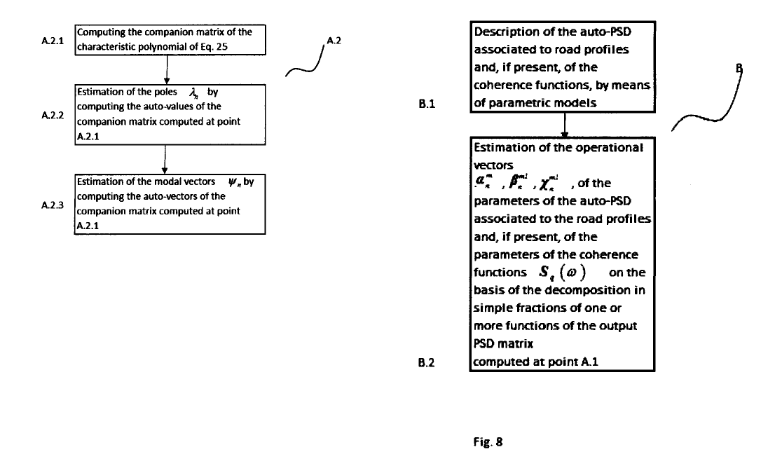

Once estimated all the operational modal parameters and the coefficients associated to the parametric models of the auto-PSD associated to profiles S_{d}(ω) and of the coherence function Γ₁(ω) it is possible to synthesize the output auto- and cross-PSD and to carry out a comparison with the non-possibility parametric estimations of the same. This last step is very interesting because it offers the analyst the to validate the results obtained. An example of such comparison is shown in FIG. 4), where the auto-PSD is reported, computed starting from the movements detected by the sensor arranged on the right frontal non-suspended mass (zᵤ_{₁} in FIG. 2)). The perfect superimposition between the two curves confirms further the goodness of the results obtained from the proposed procedure of identification.

### ACRONYMS

FRF: Frequency Response Function

IFT: Inverse Fourier Transform

LSCF: Least Squares Complex Frequency

MAC: Modal Assurance Criterion

NExT: Natural Excitation Technique

OMA: Operational Modal Analysis

PSD: Power Spectral Density

### LIST OF SYMBOLS

αₙ^{m}, βₙ^{ml} and χₙ^{ml}∈ [symbol] ^{N×1} and operational vectors.

βᵢⱼ(v)=difference between the phases associated to spectra of the two profiles dᵢ(x) and dⱼ(x).

γᵣ=coefficients of the interpolator polynomials of the coherence function.

Γᵢⱼ(v)=coherence function

λₙ=system poles

φ̅ₙ(τ)∈ [symbol] ^{N×1}=lag-dependent operational reference vectors

ϕₙ∈ [symbol] ^{N×1}=operational reference vectors

ϕᵢₙ and ϕⱼₙ components of the operational vector ϕₙ

ψₙ∈ [symbol] ^{N×1}=modal vectors

ψᵢₙ, ψⱼₙ=components of the modal vector ψₙ

v₀=spatial frequency of reference

τₗ=Lₗ/v=lag

η₁ₘ₊₁(τ)=IFT of the coherence function Γ₁ₘ₊₁(ω) computed between the profiles d₁ and dₘ₊₁;

σᵣ=coefficients of the interpolator polynomial of the auto-PSD associated to the profiles;

Ωᵣ(107 )=polynomial function

$$A ( ω ) = {\sum }_{r = 0}^{{n}_{g}} {( i ω )}^{r} {a}_{r} = polynomial of the denominator common to all the PSDs$$

B(ω)∈ [symbol] ^{N×N}=matrix of the numerator polynomials associated to the generic PSD

dᵢ(x), dⱼ(x)=parallel profiles along the road surface defined in function of the abscissa x

H_{fr}(ω)∈ [symbol] ^{N}^{ᵢ}^{×N}^{ₜ}=matrix of the response functions in frequency of the wheels

Lₗ=wheelbase

n_{g}=number of coefficients of the interpolator polynomials of the coherence functions

nₛ=number of the coefficients of the interpolator polynomial of the auto-PSD associated to profiles;

Nₜ=number of wheels

qᵢ, qⱼ=Output

R_{d}(τ)=function of the auto-correlation associated to profiles

R_{q}(τ)∈ [symbol] ^{N×N}=output correlation matrix;

R_{q}_{ᵢ}_{q}_{ⱼ}(τ)=output correlation function

S_{d}=PSD referred to the road or rail surface

S_{d}_{ᵢ}(v), S_{d}_{ⱼ}(v)=auto-PSD associated to profiles dᵢ(x) and dⱼ(x), respectively;

S_{d}_{ᵢ}_{d}_{ⱼ}(v)=cross-PSD computed between profiles dᵢ(x) and dⱼ(x)

S_{f}=input PSD matrix

S_{q}(ω)∈ [symbol] ^{N×N}=output PSD matrix;

S_{q}_{ᵢ}_{q}_{ⱼ}(ω)=Power Spectral Cross-Density

Sᵣ(ω)=PSD matrix referred to the movements induced by the surface

Tₛ=sampling period

v=advancement speed of the vehicle

W=distance between two parallel profiles dᵢ(x), dⱼ(x)

Wₘ=trackwidth

1. Method for the estimation of poles (λₙ), modal vectors (ψₙ) and operational vectors (αₙ^{m}, βₙ^{ml}, χₙ^{ml}) of a road or rail vehicle provided with at least two wheels, by means of the analysis of the displacements and/or velocities and/or accelerations (outputs of the system) acquired in assigned measuring points of said vehicle,
wherein the inputs induced by the road or rail surface on said vehicle cannot be traced back to a sequence of white noises and wherein said inputs are correlated with respect to each other in time and/or space
the method comprising the steps of:
driving a vehicle at constant speed;
measuring displacements and/or velocities and/or accelerations in assigned measuring points of said vehicle (outputs);
calculating the matrix of the power spectral densities of said outputs (S_{q}(ω)) acquired at the previous step;
defining a model descriptive of the matrix of the power spectral densities of said outputs (S_{q}(ω)), said model being dependent on said operational vectors;
determining said poles, modal vectors and operational vectors so that said model fits said matrix of the power spectral densities of said outputs (S_{q}(ω)), for example by minimizing the squared error;
characterized in that said operational vectors comprise complex exponential terms which allow to explain the effects on said outputs of the time correlation existing between the inputs applied to wheels arranged on different axles.

2. Method according to claim 1 wherein said model descriptive of the matrix of the power spectral densities of said outputs (S_{q}(ω)) dependent on said operational vectors comprises a linear combination of the operational vectors (αₙ^{m}, βₙ^{ml}, χₙ^{ml}) multiplied times the auto-PSD (S_{d}(ω)) associated to road or rail profiles parallel to each other which said wheels move on, and times the coherence functions (Γₘ(ω)) associated to said profiles.

3. Method according to claim 1 wherein said model is a polynomial model and wherein said poles (λₙ) and said modal vectors (ψₙ) are estimated by determining eigen-values and eigen-vectors of the companion matrix associated to the characteristic polynomial relative to said polynomial model.

4. Method according to claim 2 further comprising:
the description of the auto-PSD associated to profiles (S_{d}(ω)) by means of a suitably chosen parametric model and
the estimation of coefficients of said parametric model of the auto-PSD associated to said road or rail profiles (S_{d}(ω))

5. Method according to claim 4 further comprising the description of said coherence functions (Γₘ(ω)), by means of a suitably chosen parametric model and the estimation of coefficients of said parametric model of the coherence functions (Γₘ(ω)).

6. Program for programmable devices containing instructions which, when carried out, realize the method for estimation of poles (λₙ), modal vectors (ψₙ) and operational vectors (αₙ^{m}, βₙ^{ml}, χₙ^{ml}) of a road or rail vehicle, according to claim 1

7. Device for the estimation of poles (λₙ), modal vectors (ψₙ) and operational vectors (αₙ^{m}, βₙ^{ml}, χₙ^{ml}) of a road or rail vehicle comprising:
a series of sensors positioned on said vehicle and configured to acquire and store, on an electronic support, data relative to said outputs; and
electronic devices comprising a program for programmable device, according to claim 6.
